(19) United States
(12) Patent Application Publication
(10) Pub. No.: US 2017/0138123 A1
(43) Pub. Date: May 18, 2017

(54) WINDOW BLIND

(71) Applicant: NIEN MADE ENTERPRISE CO., LTD., Taichung City (TW)

(72) Inventors: Lin CHEN, Taichung (TW); Keng-Hao NIEN, Taichung (TW)

(21) Appl. No.: 15/297,043

(22) Filed: Oct. 18, 2016

(30) Foreign Application Priority Data
Nov. 17, 2015 (CN) 201520914905.X
Jan. 15, 2016 (CN) 201620036507.7

(51) Int. Cl. E06B 9/307; E06B 9/322; E06B 9/304

(52) U.S. Cl. CPC E06B 9/307; E06B 9/304; E06B 9/322

(57) ABSTRACT

A window blind includes a control structure and an adjusting member. The control structure is adapted to move a bottom rail relative to a headrail, whereby to lower and raise the window blind. The adjusting member is adapted to move ladders to tilt the slats, allowing a different amount of light to travel through the window blind. Particularly, the adjusting member provides a two-step adjusting function. Whereby, the window blind could provide a good shielding effect when the window blind is completely lowered.

### BACKGROUND OF THE INVENTION

1. Technical Field

The present invention relates generally to adjusting slats of a window covering, and more particularly to a window blind having a two-step adjustment for tilt angles of the slats thereof.

2. Description of Related Art

A conventional window blind would include a headrail, a bottom rail, and a plurality of slats, wherein the slats are usually suspended in parallel between the headrail and the bottom rail through two ladders. Each ladder has two vertical strings, and a tilt angle of the slats could be adjusted by reeling in one vertical string and releasing the other vertical string at the same time through an adjustment mechanism. In addition, the window blind could be raised or lowered by pulling an operating cord to reel in/out two lifting cords respectively.

In such a conventional window blind, there would be two independent mechanisms responsible for raising/lowering the window blind and adjusting the tilt angle of the slats, which is quite inconvenient for operation. Therefore, some manufacturers in the industry have developed a kind of control module, which has said two mechanisms integrated therein. However, such control module, as disclosed in the Taiwan utility model patent M269349 and M356795, would only be compatible with window blinds having a lifting cord passing through all of the slats. Though the aforementioned problems seem to be solved, the lifting cord would be located between two vertical strings of a ladder, so that each two adjacent slats may have a slit left therebetween even if the window blind is fully expanded, and light would still leak in through those slits.

Furthermore, in order to raise/lower the window blind and to adjust the tilt angle of the slats with one single control module, the window blind would be designed to be lowered with its own weight. However, the friction between the lifting cord and the slats would gradually increase while the slats are rotated toward a vertical position, which affects the smoothness of the operation of lowering the window blind. In other words, to lower such a window blind, the slats could not be tightly closed (i.e., in a vertical position) to avoid the excessive friction. As a result, the slats would not be able to completely close after the window blind is lowered. In addition, to lower the window blind smoothly, an additional force would be generally required to pull the lifting cord tight to overcome the friction between the lifting cord and the slats. A common way of doing so is to provide a counterweight to the bottom rail, but a heavy bottom rail would make lifting the window blind more difficult. On the contrary, though a lighter bottom rail would make the raising of the window blind effortless, the operation of lowering the window blind would become less smooth, and the slats could not be tightly closed. In all aspects, the window blind with one single control module still has room for improvements.

### BRIEF SUMMARY OF THE INVENTION

In view of the above, the primary objective of the present invention is to provide a window blind, which provides a good shielding effect when the window blind is completely lowered.

The present invention provides a window blind, wherein the window blind includes a headrail, a bottom rail, and a plurality of slats, wherein the slats are suspended in parallel between the headrail and the bottom rail through at least one ladder. The window blind further includes a control structure and an adjusting member. The control structure includes a driving shaft and a lifting cord, wherein the driving shaft is controllable to be rotated around an axis thereof either clockwise or counter-clockwise, and is provided in the headrail. A reeling portion is provided on the driving shaft. The lifting cord is connected to the reeling portion with an end thereof, wherein the lifting cord extends out of the headrail to be connected to the bottom rail with another end thereof. The adjusting member is adapted to tilt the slats, wherein the adjusting member includes a shaft seat, a wheel, a friction ring, a transmission member, and a blocking member. The shaft seat is provided in the headrail, and has a first blocking portion. The wheel has an outer circular surface, and is provided in the shaft seat, wherein the wheel is adapted to be rotated along with the driving shaft in the same direction synchronously. The friction ring has an inner circular surface facing the outer circular surface of the wheel, two fixing portions, and a projection located between the fixing portions, wherein the fixing portions are respectively connected to one end of each of two vertical strings of the at least one ladder. The vertical strings are respectively located on two lateral sides of a center of the wheel. The transmission member is engaged with the driving shaft, and is adapted to be moved between a first position and a second position along with the driving shaft when the driving shaft is rotated around the axis thereof clockwise or counter-clockwise. The blocking member is provided in the shaft seat opposite to the first blocking portion of the shaft seat, and is movable by the transmission member. When the transmission member arrives at the first position, the blocking member is located on a moving path of the projection of the friction ring; when the transmission member arrives at the second position, the blocking member leaves the moving path of the projection of the friction ring. Whereby, when the transmission member is moved between the first position and the second position, the friction ring stops rotating either because one of the fixing portions thereof abuts against the first blocking portion or because the projection thereof abuts against the blocking member. The slats stop tilting in either way. By continuously rotating the driving shaft, the lifting cord is reeled in or released from the reeling portion. When the transmission member arrives at the second position, the friction ring is rotated along with the wheel to tilt the slats again.

By rotating the driving shaft around the axis thereof either clockwise or counter-clockwise, the transmission member could be moved between the first position and the second position, and one of the fixing portions of the friction ring would abut against the first blocking portion. Alternatively, by abutting the protrusion of the friction ring against the blocking member, the friction ring would stop rotating, so that the slats would stop tilting as well, and the driving shaft could be operated to continuously rotate for reeling in or releasing the lifting cord. When the transmission member is moved to the second position, the friction ring would rotate along with the wheel to tilt the slats, whereby the slats would be tilted again to change the tilt angle thereof.

In an embodiment, a tapped hole is provided at one end of the transmission member. A threaded portion is provided on the driving shaft, passing through the tapped hole. Another end of the transmission member opposite to the tapped hole is confined to prevent the transmission member from being rotated along with the driving shaft, whereby the transmission member is horizontally movable between the first position and the second position in an axial direction of the driving shaft.

In an embodiment, the adjusting member includes a bar and a switch member. The bar is parallel to the driving shaft; the switch member and the blocking member are connected to the bar, and are both not rotatable relative to the bar. The transmission member has a sloping surface. When the transmission member is moved toward the second position, the sloping surface gradually pushes the switch member toward outside to rotate the bar. The rotating bar moves the blocking member to leave the moving path of the projection of the friction ring.

In an embodiment, the adjusting member includes a bar and an abutting member. The bar is parallel to the driving shaft; the abutting member and the blocking member are connected to the bar. When the transmission member is moved toward the second position, the transmission member pushes the abutting member to move the bar in the axial direction; the moving bar moves the blocking member to leave the moving path of the projection of the friction ring.

In an embodiment, the adjusting member comprises a base provided in the headrail. The control structure comprises a bolt, which has a head, a threaded body, and a shaft bore going through the head and the threaded body. The head has a circular groove, which is adapted to be engaged with a side wall of the base. The threaded body is located in the base, and forms the threaded portion. The driving shaft passes through the shaft bore, wherein the shaft bore corresponds to a shape of a cross section of the driving shaft, and the cross section is not circular.

In an embodiment, a vertical first abutting surface is provided on another side wall of the base, a second abutting surface is provided at another end of the transmission member, wherein the another end is opposite to the end with tapped hole. The first abutting surface abuts against the second abutting surface, whereby the transmission member is not rotatable along with the driving shaft.

In an embodiment, the control structure comprises a reel fitting around the driving shaft and located on one side of the shaft seat to form the reeling portion. The reel is not rotatable relative to the driving shaft.

In an embodiment, the shaft seat of the adjusting member further has a second blocking portion, which is opposite to the first blocking portion. When the transmission member is moved to the second position and the other one of the fixing portions of the friction ring abuts against the second blocking portion, the friction ring stop rotating to stop tilting the slats.

In an embodiment, a circular recess recessed into the outer circular surface of the wheel. The friction ring is a semicircular frame, and two ends of the friction ring form the fixing portions. A rib bulges from the inner circular surface of the friction ring, and the rib is engaged with the circular recess.

In an embodiment, two circular recesses recess into the outer circular surface of the wheel. The friction ring includes a first circular body and a second circular body which are connected to each other. The first circular body and second circular body are both discontinuous rings, each of which is greater than half of a circle. One of the fixing portions is formed at a free end of the first circular body, while the other one of the fixing portions thereof is formed at a free end of the second circular body. A rib bulges from an inner circular surface of the first circular body, and another rib bulges from an inner circular surface of the second circular body, wherein each of the ribs is engaged with one of the circular recesses.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of a first embodiment of the present invention;

FIG. 2 is a side view of FIG. 1, showing the slats are tightly closed;

FIG. 3 is a perspective view, showing the control structure and the adjusting member of the first embodiment;

FIG. 4 is a top view of FIG. 3, showing the transmission member is located at the second position;

FIG. 5 and FIG. 7 are exploded views, showing part of the components of the control structure and the adjusting member in FIG. 3;

FIG. 6 is a perspective view, showing the relation between the wheel of the adjusting member and the friction ring in FIG. 3;

FIG. 8 is sectional view along the 8-8 line in FIG. 4, showing the blocking member is substantially erect, and is not on the moving path of the protrusion of the friction ring;

FIG. 9 is similar to FIG. 8, showing the blocking member is located on the moving path of the protrusion of the friction ring, and the first fixing portion abuts against the first blocking portion;

FIG. 10 is similar to FIG. 2, showing the slats are synchronously rotated counter-clockwise and backward;

FIG. 11 is similar to FIG. 4, showing the transmission member is located at the first position;

FIG. 12 is a perspective view, showing the window blind of the first embodiment is completely raised;

FIG. 13 is similar to FIG. 9, showing the protrusion of the friction ring abuts against the blocking member;

FIG. 14 is similar to FIG. 2, showing the bottom rail is lowered, and the slats rotate clockwise one by one from top down;

FIG. 15 is a side view, showing the bottom rail reaches the lowest position;

FIG. 16 is an exploded perspective view, showing the wheel and the friction ring of a second embodiment of the present invention;

FIG. 17 is a sectional view, showing the relation between the wheel and the friction ring in FIG. 16; and

FIG. 18 is a perspective view, showing the control structure and the adjusting member of a third embodiment of the present invention.

### DETAILED DESCRIPTION OF THE INVENTION

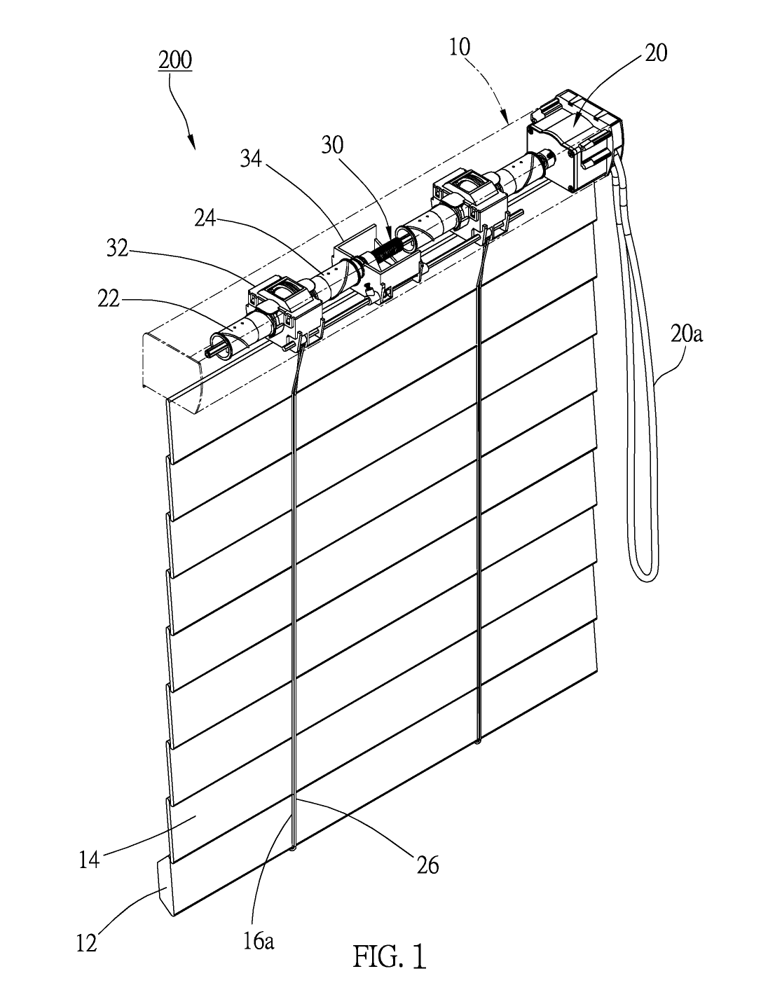

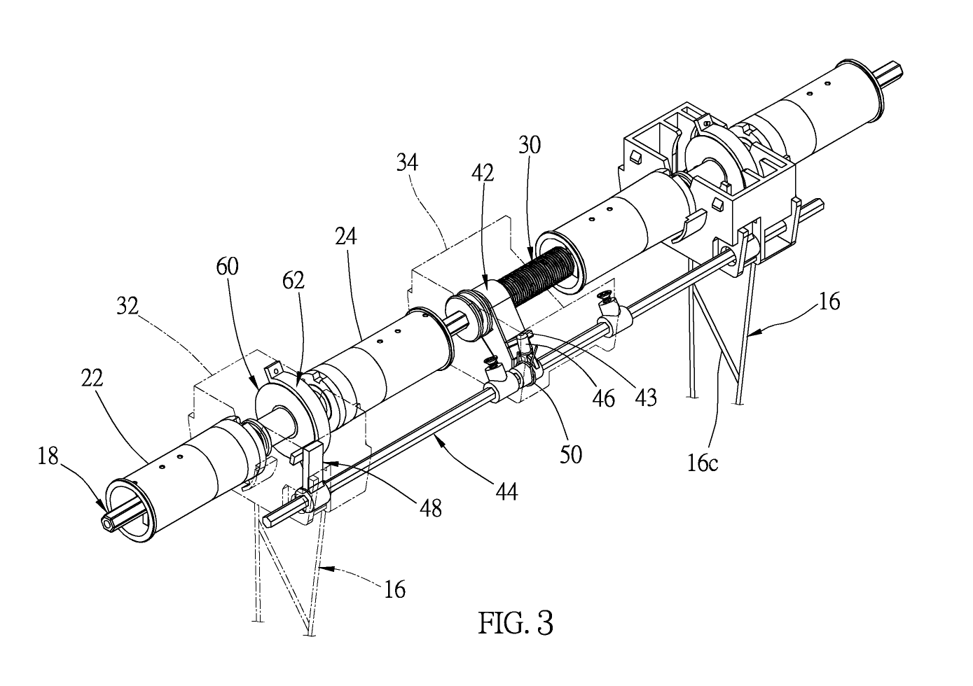

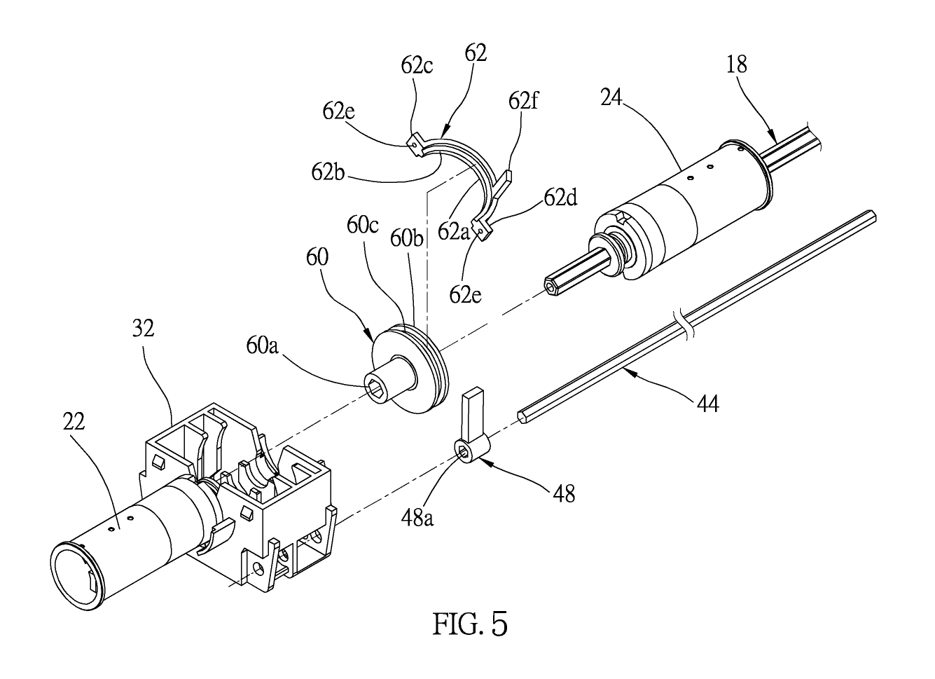

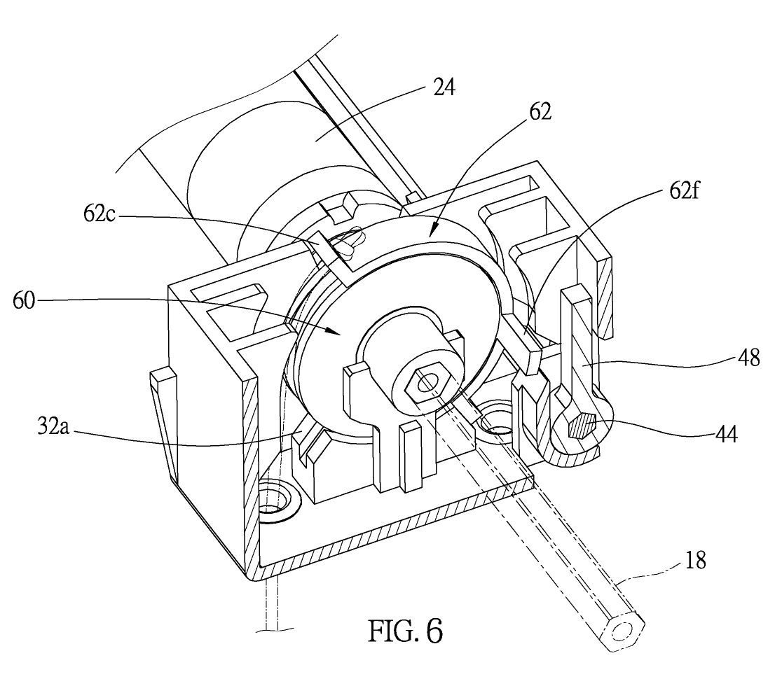

A window blind 200 of a first embodiment of the present invention is illustrated in FIG. 1 to FIG. 8, including a headrail 10, a bottom rail 12, and a plurality of slats 14, wherein the slats 14 are suspended in parallel between the headrail 10 and the bottom rail 12 through two ladders 16. The window blind 200 further includes a control structure and an adjusting member, wherein the control structure is adapted to move the bottom rail 12 relative to the headrail 10, whereby to lower and raise the window blind 200. The adjusting member is adapted to move the ladders 16 to tilt the slats 14, allowing a different amount of light to travel through the window blind 200. In the following paragraphs, detailed components of the control structure and the adjusting member will be explained first, while the operation thereof will be described in detail later.

The control structure includes a driving shaft 18, a control module 20, a first reel 22, a second reel 24, a first lifting cord 26, a second lifting cord 28, and a bolt 30. The driving shaft 18 is long, and a cross section thereof is polygonal. The driving shaft 18 is provided in the headrail 10 horizontally, wherein an end of the driving shaft 18 is connected to the control module 20. The driving shaft 18 could be rotated around an axis thereof either clockwise or counter-clockwise by an operating cord 20a of the control module 20. In the first embodiment, the driving shaft 18 could be driven manually. In practice, the driving shaft 18 could be also driven by electrical control.

The first reel 22 and the second reel 24 of the control structure fit around the driving shaft 18, wherein the first reel 22 and the second reel 24 could not rotate relative to the driving shaft 18, and respectively have a reeling portion formed thereon. In the first embodiment, the first reel 22 and the second reel 24 respectively have a polygonal bore (not shown) corresponding to the shape of the cross section of the driving shaft 18. Whereby, the driving shaft 18, which passes through the first reel 22 and the second reel 24, could rotate the first reel 22 and the second reel 24 in the same direction synchronously.

The first lifting cord 26 is connected to the first reel 22 with an end thereof, and extends out of the headrail to be connected to the bottom rail 12 with another end thereof. Similarly, the second lifting cord is connected to the second reel 24 with an end thereof, and also extends out of the headrail to be connected to the bottom rail 12 with another end thereof. In the first embodiment, the first lifting cord 26 and the second lifting cord 28 are respectively located near two vertical strings 16a, 16b of one of the ladders 16, and outside of the slats 14. In this way, by rotating the driving shaft 18 around the axis thereof either clockwise or counter-clockwise, the first lifting cord 26 and the second lifting cord 28 would respectively wind around the first reel 22 and the second reel 24, which raises the window blind 200, or be respectively released from the first reel 22 and the second reel 24, which lowers the window blind 200.

Both of said first reel 22 and said second reel 24 are respectively an independent drum, and respectively have a reeling portion formed thereon. In practice, two reeling portions could be integrally made on the driving shaft 18. It needs to be clarified that, though the number of said first reel 22, said second reel 24, said first lifting cord 26, and said second lifting cord 28 is one in our description, it is only for the purpose of simplifying the explanation. Preferably, the number of each of these components could be at least two, as illustrated in FIG. 1, whereby to provide better stability.

Furthermore, though the first lifting cord 26 and the second lifting cord 28 are provided outside of the slats 14, such arrangement is not a limitation of the present invention. In other embodiments, a perforation could be provided in the middle of each of the slats, and a single one lifting cord is provided passing through each of the perforations, which could also realize the function of raising and lowering the window blind 200. In other words, the numbers and the positions of the reels and the lifting cords are irrelevant to the present invention.

The bolt 30 of the control structure includes a head 30a, a threaded body 30b, and a shaft bore 30c going through the head 30a and the threaded body 30b, wherein the threaded body 30b is defined as a threaded portion. However, in practice, the driving shaft 18 and the threaded portion could be also integrally made. The shaft bore 30c is a polygonal bore corresponding to the shape of the cross section of the driving shaft 18. The driving shaft 18 passes through the shaft bore 30c, whereby the shaft bore 30c could be rotated in the same direction synchronously along with the driving shaft 18.

The adjusting member includes a shaft seat 32, a base 34, a transmission member 42, a bar 44, a switch member 46, a blocking member 48, a volute spring 50, a wheel 60, and a friction ring 62, wherein the shaft seat 32 and the base 34 are provided in the headrail 10.

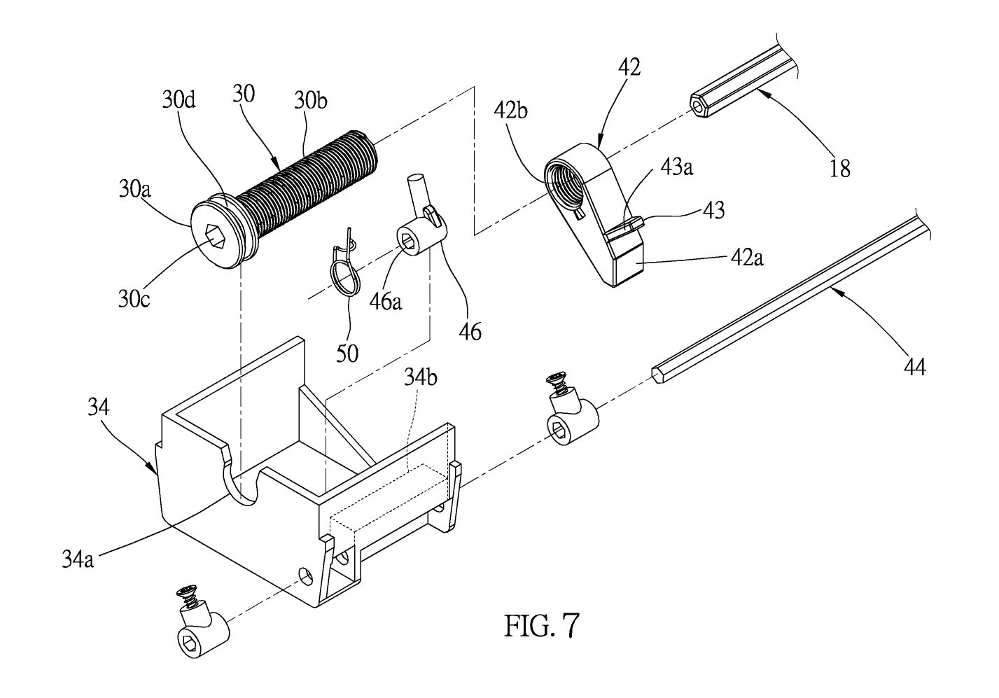

The shaft seat 32 is provided between the first reel 22 and the second reel 24, and a protrusion bulges from a bottom of the shaft seat 32. As shown in FIG. 8, two lateral sides of the protrusion are respectively defined as a first blocking portion 32a and a second blocking portion 32b.

A notch 34a is provided on a side wall of the base 34. A vertical first abutting surface 34b is provided on an inner side of another side wall. The head 30a of the bolt 30 has a circular groove 30d, wherein the circular groove 30d could engage with the notch 34a, so that the bolt 30 could be rotatable only at where it is. The threaded body 30b is located in the base 34.

The wheel 60 is provided in the shaft seat 32, and has a polygonal bore 60a corresponding to the shape of the cross section of the driving shaft 18. The driving shaft 18 passes through the polygonal bore 60a to rotate the wheel 60 in the same direction synchronously. The wheel 60 has an outer circular surface 60b and a circular recess 60c recessed into the outer circular surface 60b. In practice, the wheel could be also integrally made on the driving shaft 18.

The friction ring 62 is provided above the wheel 60, and has an inner circular surface 62a facing the outer circular surface 60b of the wheel 60. In the first embodiment, the friction ring 62 is a semicircular frame. A rib 62b bulges from the inner circular surface 62a thereof, wherein the rib 62b is engaged with the recess 60c. Two ends of the friction ring 62 respectively form a fixing portion, which are respectively a first fixing portion 62c and a second fixing portion 62d. Each fixing portion has a bore 62e adapted to be passed through by one end of the corresponding vertical strings 16a, 16b of one of the ladders 16, so that said ladder 16 could be fixedly connected to the friction ring 62. As shown in FIG. 8, the vertical strings 16a, 16b are respectively located on two lateral sides of a center of the wheel 60. Since the slats 14 are suspended through the ladders 16, the friction ring 62 connected to the vertical strings 16a, 16b would abut against the wheel 60 due to the effects of gravity, so that the rib 62b would always contact with the circular recess 60c. In addition, the friction ring 62 has a projection 62f provided between the first fixing portion 62c and the second fixing portion 62d in an axial direction. In this way, the friction ring 62 would abut against the wheel 60, and the friction ring 62 could be moved along with the rotation of the wheel 60, whereby the projection 62f would move along a curved path.

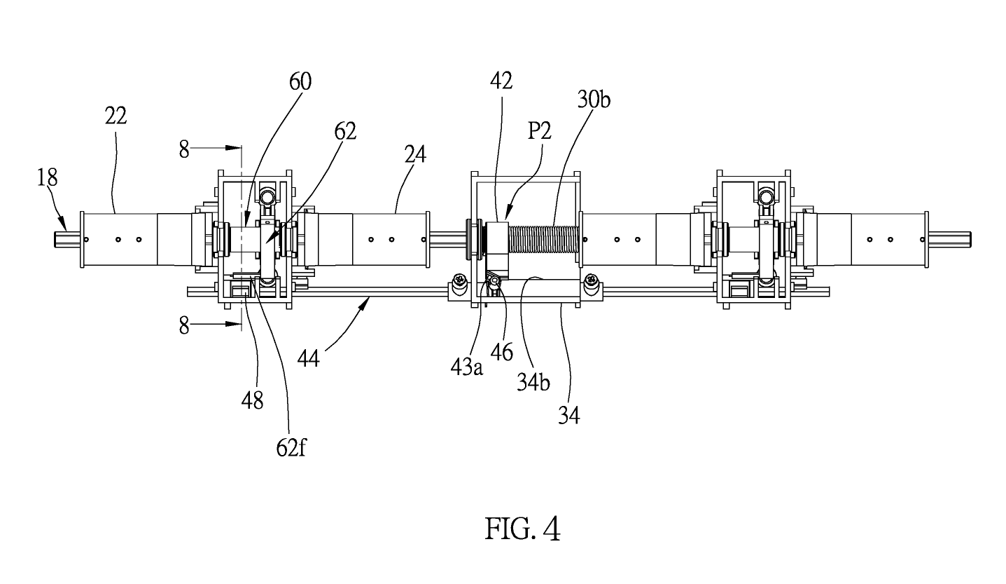

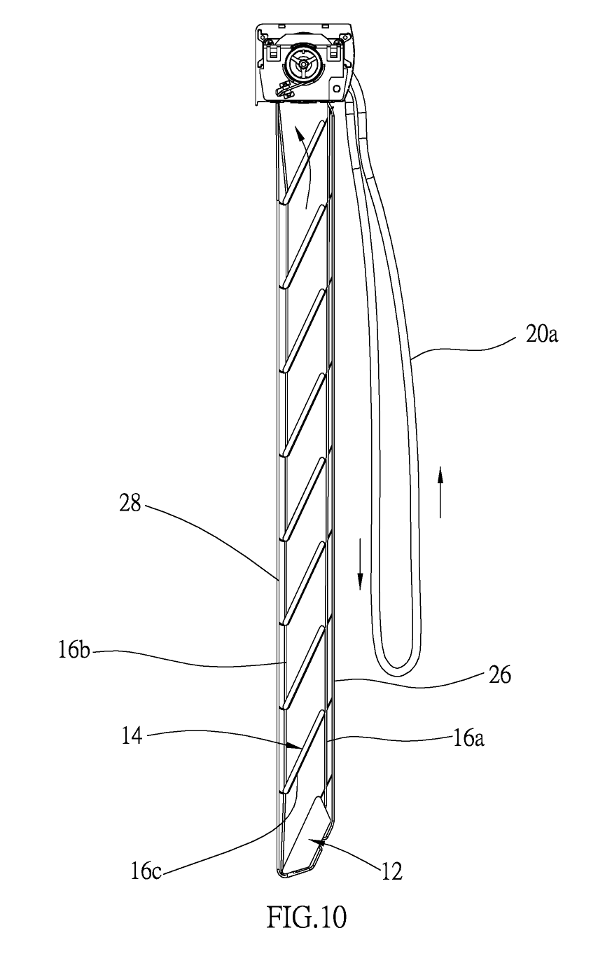

The transmission member 42 is a long block, and is located in the base 34, wherein a second abutting surface 42a and a tapped hole 42b are respectively provided at two ends of the transmission member 42. A plate 43 is provided between the second abutting surface 42a and the tapped hole 42b, wherein the plate 43 has a sloping surface 43a. The second abutting surface 42a of the transmission member 42 abuts against the first abutting surface 34b of the base 34. The tapped hole 42b thereof is passed through by the threaded body 30b of the bolt 30 to be screwed together. As a result, when the bolt 30 is rotated either clockwise or counter-clockwise along with the driving shaft 18, the transmission member 42 would move between a first position P1 (shown in FIG. 11) and a second position P2 (shown in FIG. 4). Meanwhile, the second abutting surface 42a of the transmission member 42 is confined by the first abutting surface 34b of the base 34, so that the transmission member 42 would not rotate while moving between the first position P1 and the second position P2. Said transmission member 42 is engaged with the driving shaft 18 through the bolt 30, and moves along with the rotation of the driving shaft 18.

The bar 44 is provided in the headrail 10 in parallel with the driving shaft 18, going through the shaft seat 32 and the base 34. The switch member 46 and the blocking member 48 are connected to the bar 44, and are both not rotatable relative to the bar 44. In the first embodiment, the bar 44 is long, and a cross section thereof is polygonal. The switch member 46 and the blocking member 48 are both slender, each of which respectively has a polygonal bore 46a (48a) provided on one end thereof to be passed through by the bar 44. The switch member 46 is provided in the base 34, and the blocking member 48 is located in the shaft seat 32. The volute spring 50 fits around the bar 44, and exerts a torque on the switch member 46, urging the switch member 46 to tilt in a predetermined direction.

With the aforementioned design, when the transmission member 42 moves toward the second position P2, the sloping surface 43a of the plate 43 thereof would abut against the switch member 46 on one end thereof, which is opposite to the end with the polygonal bore 46a. The switch member 46 would be gradually pushed and rotated toward the outside of the base 34, and the bar 44 would be also rotated along with the switch member 46. Whereby, the rotating bar 44 would pivot the blocking member 48. When the transmission member 42 arrives at the second position P2, the blocking member 48 would leave the moving path of the projection 62f of the friction ring 62. On the contrary, while the transmission member 42 is being moved toward the first position P1, the switch member 46 would rotate toward the inside of the base 34 due to a force of the volute spring 50 exerted thereon, and the blocking member 48 would return to the moving path of the projection 62f of the friction ring 62.

With the aforementioned structures, the method of operating the window blind 200 and tilting the slats 14 synchronously will be described below.

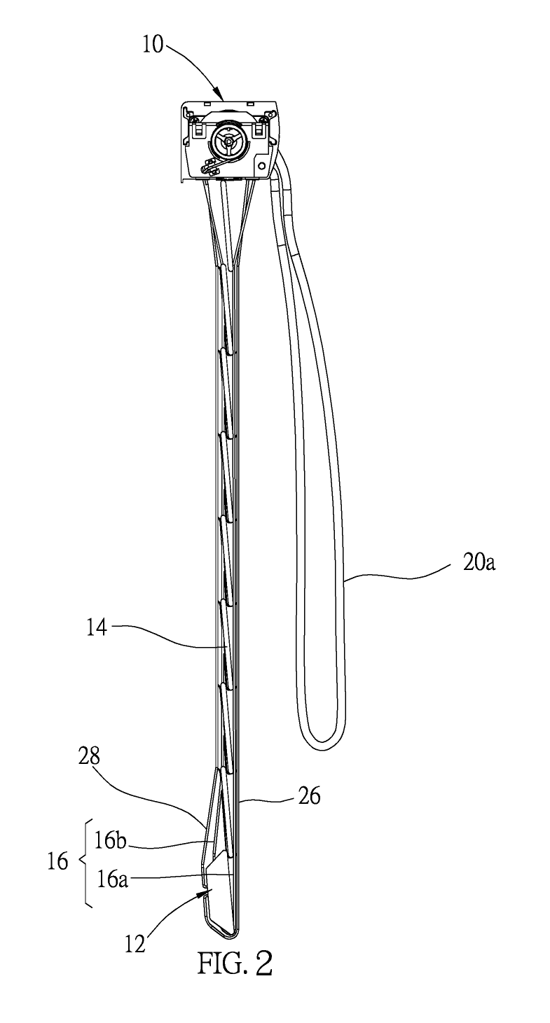

The window blind 200 illustrated in FIG. 1 and FIG. 2 is completely lowered, wherein the slats 14 are tightly closed. In the state shown in FIG. 4 and FIG. 8, the transmission member 42 is located at the second position P2, and the blocking member 48 is substantially erect and not on the moving path of the projection 62f of the friction ring 62.

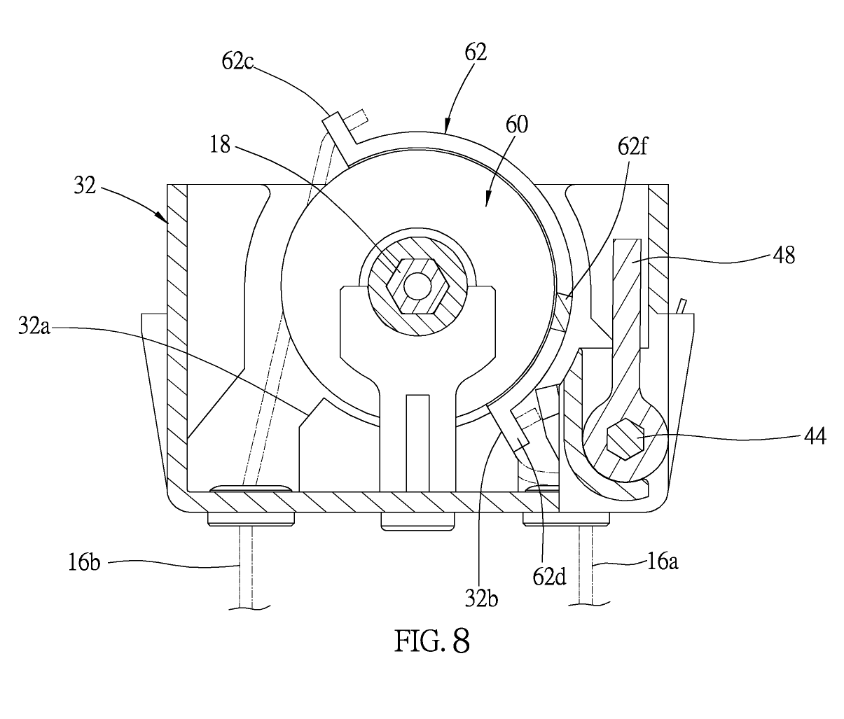

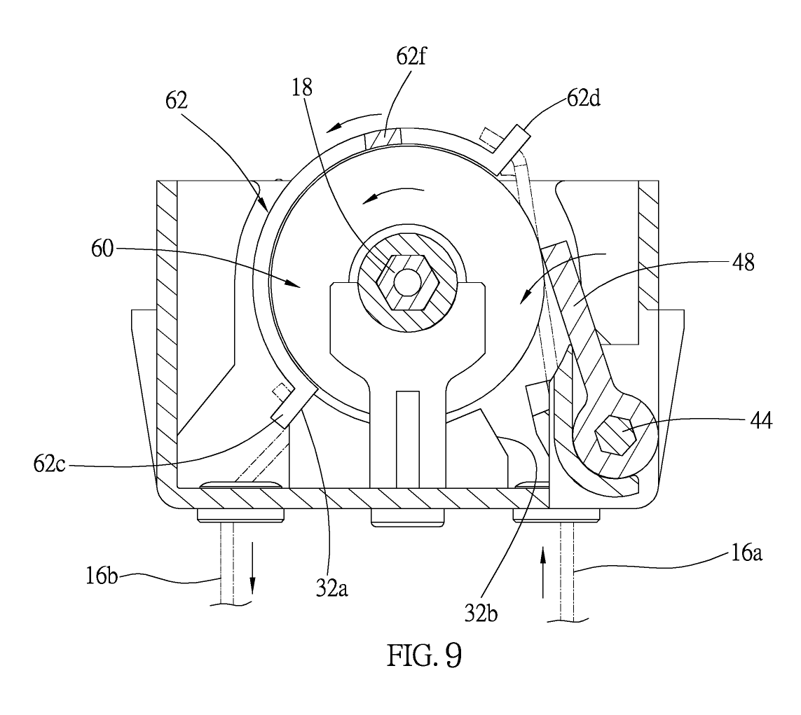

As shown in FIG. 9, by pulling the operating cord 20a, the driving shaft 18 would be rotated counter-clockwise along with the wheel 60. Due to the weight of the slats 14 and the bottom rail 12, the friction ring 62 would tightly abut against the wheel 60, and would be moved along with the wheel 60 by the friction generated therebetween. Meanwhile, by pulling one of the vertical strings (i.e., the vertical string 16a) upward and reeling out the other one of the vertical strings (i.e., the vertical string 16b) downward until the first fixing portion 62c of the friction ring 62 abuts against the first blocking portion 32a, horizontal strings 16c of the ladders 16 would be affected, whereby the closed slats 14 would be rotated counter-clockwise, becoming the state illustrated in FIG. 10, wherein each of the slats 14 tilts from upper right to lower left. In other words, the rotation of the friction ring 62 would be stopped by the first blocking portion 32a of the shaft seat 32, so that the slats 14 would stop rotating, and stay in a tilted state.

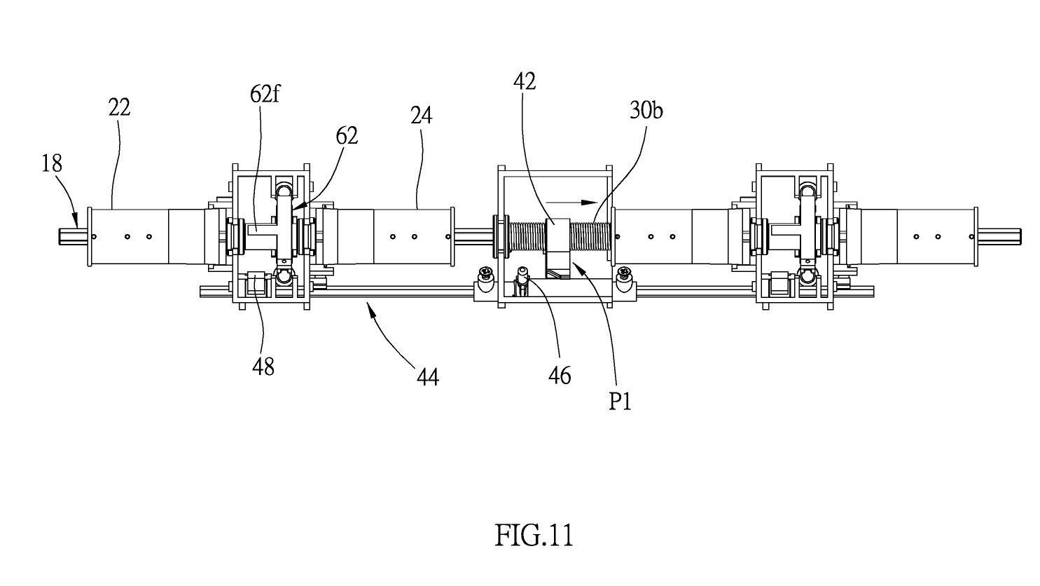

As shown in FIG. 11, when the operating cord 20a is continuously pulled to rotate the driving shaft 18 counter-clockwise by a force greater than the friction generated between the wheel 60 and the friction ring 62, the first lifting cord 26 and the second lifting cord 28 would gradually wind around the first reel 22 and the second reel 24 respectively. When the transmission member 42 leaves second position P2, the blocking member 48 would return to the moving path of the projection 62f of the friction ring 62 as being indirectly affected by the volute spring 50 (as shown in FIG. 9). When the transmission member 42 arrives at the first position P1, the window blind 200 would be completely raised (as shown in FIG. 12).

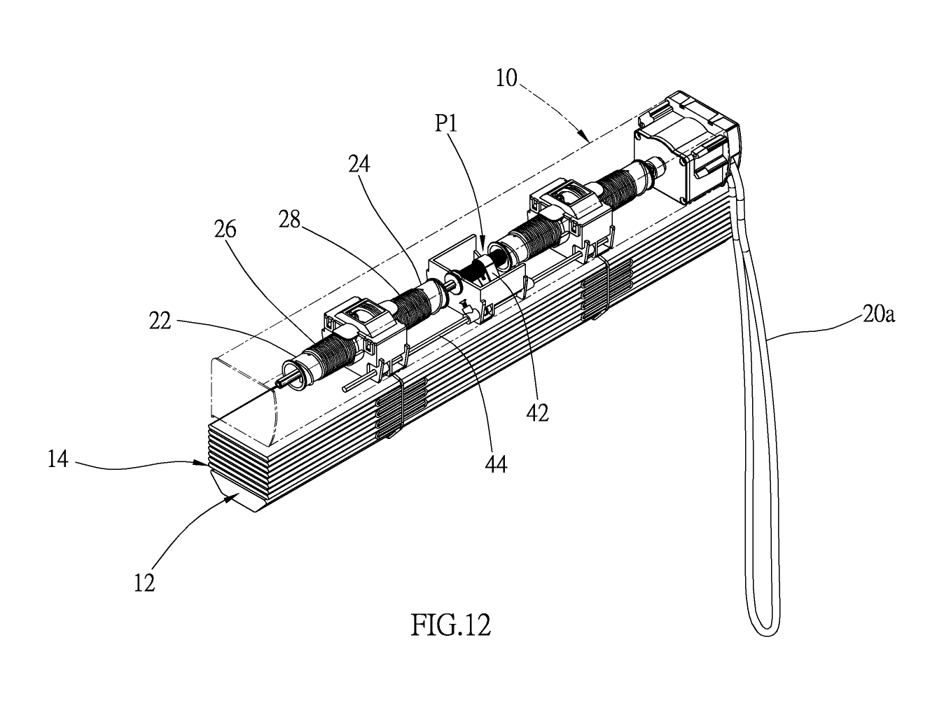

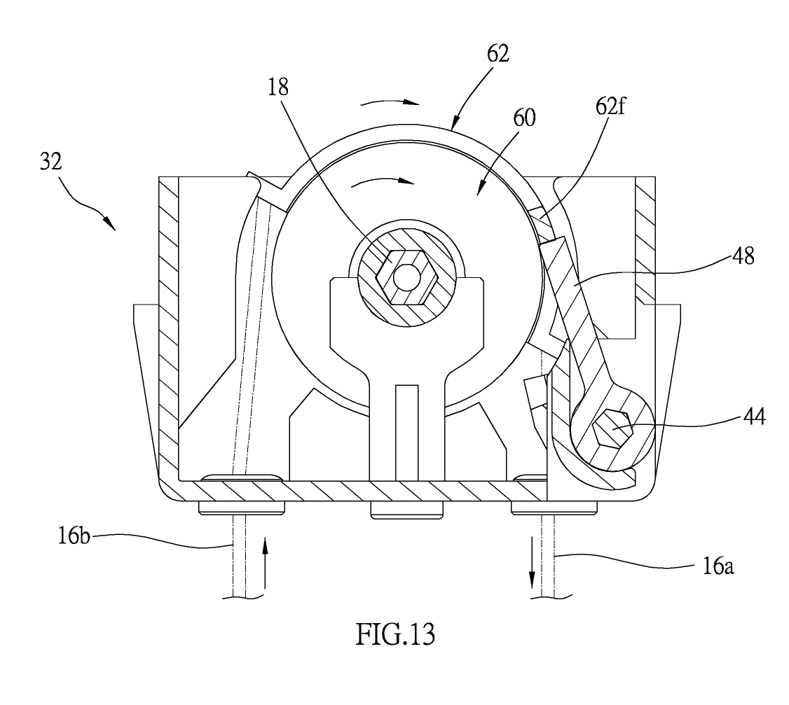

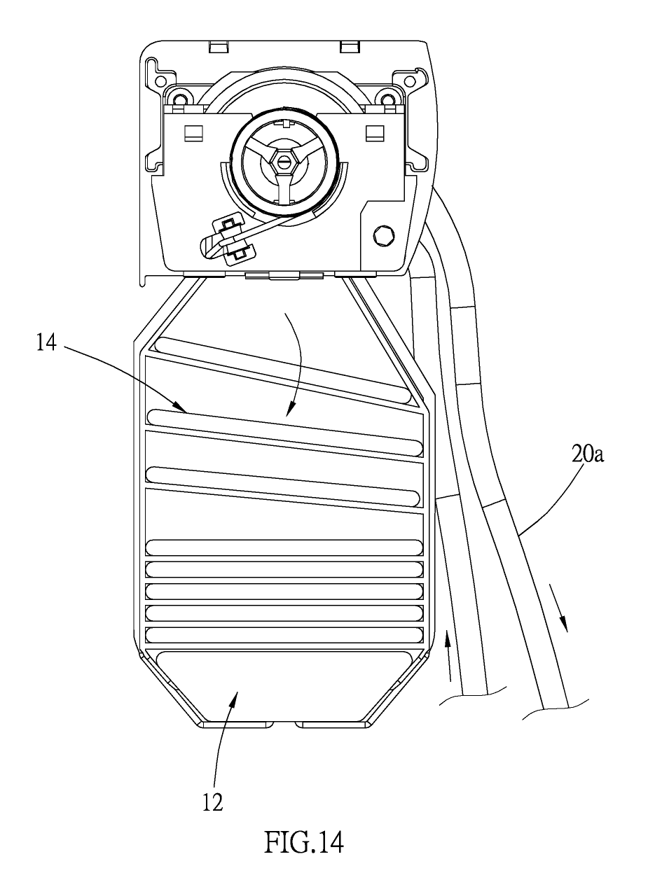

By maneuvering the operating cord 20a to make the driving shaft 18 rotate clockwise along with the wheel 60, the raised window blind 200 could be lowered. As shown in FIG. 13, while the driving shaft 18 is rotating clockwise, the friction ring 62 would abut against the wheel 60 due to the effect of gravity, and therefore would be moved along with the wheel 60 by the friction generated therebetween. The friction ring 62 would stop moving once the projection 62f thereof abuts against a top of the blocking member 48. The state shown in FIG. 14 is when the operating cord 20a is continuously pulled, wherein the first reel 22 and the second reel 24 would be operated to gradually reel out the first lifting cord 26 and the second lifting cord 28. Since the slats 14 has rotated clockwise for a distance in advance due to the friction ring 62, the slats 14 would rotate in clockwise one by one from top down during the process of lowering the bottom rail 12. When the bottom rail 12 reaches a lowest position (i.e., when the window blind 200 is completely lowered), the slats 14 would tilt from upper left to lower right as shown in FIG. 15. At this time point, an edge of each of slats 14 would not closely abut against an edge of the adjacent slat 14, so that each two adjacent slats 14 would have a slit left therebetween. A range of rotation of the slats 14 mentioned above is defined as a first-step adjustment.

While the driving shaft 18 is rotating clockwise, the transmission member 42 would be moved toward the second position P2, and gradually push the switch member 46. When the transmission member 42 is located at the second position P2, the blocking member 48 would be not on the moving path of the projection 62f of the friction ring 62 again. As shown in FIG. 8, the friction ring 62 would abut against the wheel 60 again due to the effect of gravity, and continuously rotate clockwise along with the wheel 60 until the second fixing portion 62d of the friction ring 62 abuts against the second blocking portion 32b. So that, the slats 14 could be urged to rotate clockwise quickly, and could be tightly closed as shown in FIG. 2. A range of rotation of the slats 14 during the process mentioned above is defined as a second-step adjustment.

With the aforementioned design, the slats 14 would rotate automatically while the window blind 200 of the first embodiment is being lowered and raised. In addition, since the first lifting cord 26 and the second lifting cord 28 which move the bottom rail 12 are located outside of the slats 14, the bottom rail 12 could be raised or lowered smoothly without being hindered. Furthermore, with the two-step adjustment of the slats 14, the window blind 200 could provide a good shielding effect when the window blind 200 is completely expanded.

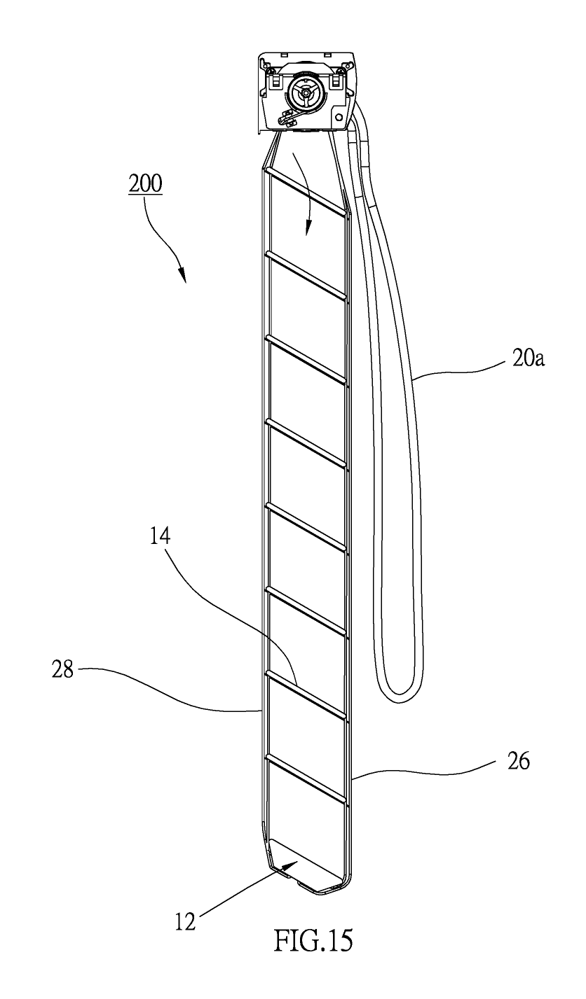

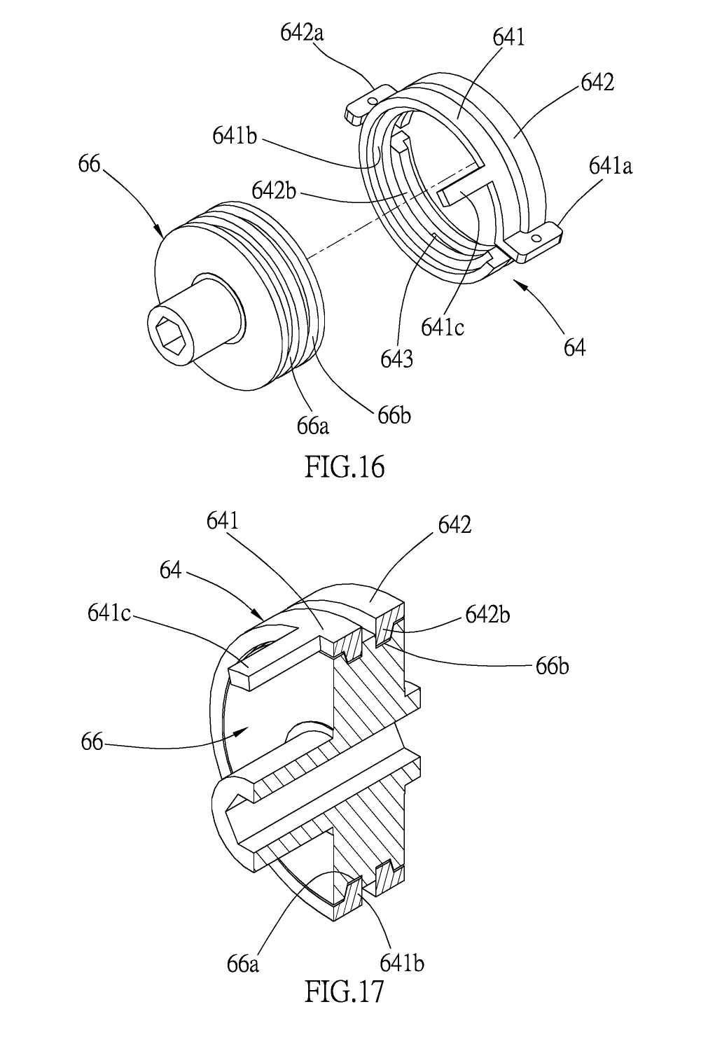

In the first embodiment, the friction ring 62 is a semicircular frame, and the friction between the friction ring 62 and the wheel 60 is generated due to the weight of the slats 14 and the bottom rail 12. Whereby, the slats 14 could be tilted by moving the wheel 60. However, the friction ring 62 is not necessary to be a semicircular frame. As shown in FIG. 16 and FIG. 17, the friction ring 64 in a second embodiment of the present invention includes a first circular body 641 and a second circular body 642, wherein the first circular body 641 and the second circular body 642 are both discontinuous rings, each of which is greater than half of a circle, and are connected through a connecting member 643. The connecting member 643 could stabilize the positions of the first circular body 641 and the second circular body 642. A first fixing portion 641a is formed at a free end of the first circular body 641, while a second fixing portion 642a is formed at a free end of the second circular body 642. The first circular body 641 further has a projection 641c. In addition, a rib 641b and a rib 642b respectively bulge from an inner circular surface of the first circular body 641 and an inner circular surface of the second circular body 642. To match the friction ring 64, a circular recess 66a and a circular recess 66b recess into an outer circular surface of a wheel 66, corresponding to one of the ribs 641b, 642b respectively, wherein each of the ribs 641b, 642b is respectively engaged with one of the circular recesses 66a, 66b, so that the wheel 66 would be surrounded by the first circular body 641 and the second circular body 642. In this way, the friction between the friction ring 64 and the wheel 66 could be increased, whereby the slats 14 could be tilted more accurately.

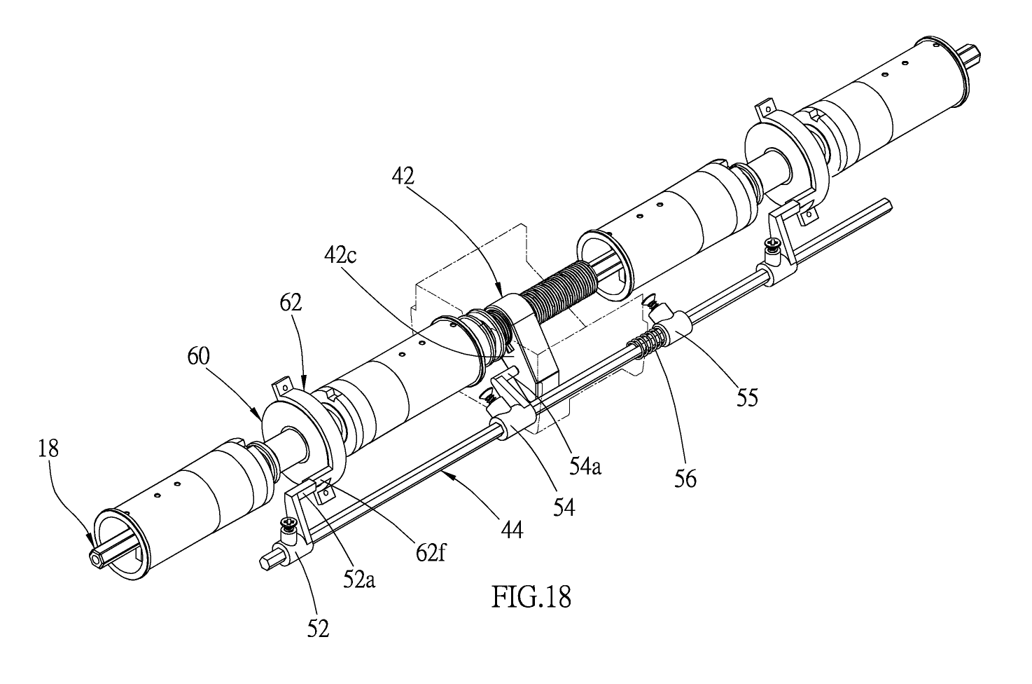

In the aforementioned embodiments, the second-step adjustment is done by manipulating the switch member 46 and the blocking member 48 to rotate synchronously, making the blocking member 48 leave the moving path of the projection 62f of the friction ring 62. However, the same purpose could be also achieved in different ways. As shown in FIG. 18, a third embodiment of the present invention includes a blocking member 52, an abutting member 54, and a fixing member 55 connected to the bar 44, wherein the blocking member 52 has a horizontally extended portion 52a on a top thereof. The switch member 46 of each of the aforementioned embodiments is replaced by the abutting member 54, which also has a horizontally extended portion 54a on a top thereof. The transmission member 42 has a lateral pushing surface 42c.

While the transmission member 42 is being moved toward the second position P2, the lateral pushing surface 42c thereof would abut against a free end of the extended portion 54a of the abutting member 54, which would move the bar 44 in an axial direction, and also moves the blocking member 52 in the axial direction at the same time. Whereby, the blocking member 52 would leave the moving path of the projection 62f of the friction ring 62. As a result, with the rotation of the wheel 60, one of the ladders 16 could complete the second-step adjustment through the rotation of the friction ring 62. On the contrary, while the transmission member 42 is being moved toward the first position P1, an elasticity of a spring 56, which fits around the bar 44 and respectively abuts against the base 34 and the fixing member 55 with two ends thereof, would urge the bar 44 to move backward, whereby the blocking member 52 would return to the moving path of the projection 62f of the friction ring 62. The effect of the aforementioned embodiments could be also achieved with the structures described herein.

It must be pointed out that the embodiments described above are only some preferred embodiments of the present invention. All equivalent structures which employ the concepts disclosed in this specification and the appended claims should fall within the scope of the present invention.

What is claimed is:

1. A window blind comprising a headrail, a bottom rail, and a plurality of slats, wherein the slats are suspended in parallel between the headrail and the bottom rail through at least one ladder; further comprising:
a control structure comprising a driving shaft and a lifting cord, wherein the driving shaft is controllable to be rotated around an axis thereof either clockwise or counter-clockwise, and is provided in the headrail; a reeling portion is provided on the driving shaft; the lifting cord is connected to the reeling portion with an end thereof, wherein the lifting cord extends out of the headrail to be connected to the bottom rail with another end thereof;
an adjusting member adapted to tilt the slats, wherein the adjusting member comprises a shaft seat, a wheel, a friction ring, a transmission member, and a blocking member; the shaft seat is provided in the headrail, and has a first blocking portion; the wheel has an outer circular surface, and is provided in the shaft seat, wherein the wheel is adapted to be rotated along with the driving shaft in the same direction synchronously; the friction ring has an inner circular surface facing the outer circular surface of the wheel, two fixing portions, and a projection located between the fixing portions, wherein the fixing portions are respectively connected to one end of each of two vertical strings of the at least one ladder; the vertical strings are respectively located on two lateral sides of a center of the wheel; the transmission member is engaged with the driving shaft, and is adapted to be moved between a first position and a second position along with the driving shaft when the driving shaft is rotated around the axis thereof clockwise or counter-clockwise; the blocking member is provided in the shaft seat opposite to the first blocking portion of the shaft seat, and is movable by the transmission member; when the transmission member arrives at the first position, the blocking member is located on a moving path of the projection of the friction ring; when the transmission member arrives at the second position, the blocking member leaves the moving path of the projection of the friction ring;
whereby, when the transmission member is moved between the first position and the second position, the friction ring stops rotating either because one of the fixing portions thereof abuts against the first blocking portion or because the projection thereof abuts against the blocking member; the slats stop tilting in either way; by continuously rotating the driving shaft, the lifting cord is reeled in or released from the reeling portion; when the transmission member arrives at the second position, the friction ring is continuously rotated along with the wheel to tilt the slats again.

2. The window blind of claim 1, wherein a tapped hole is provided at one end of the transmission member; a threaded portion is provided on the driving shaft, passing through the tapped hole; another end of the transmission member opposite to the tapped hole is confined to prevent the transmission member from being rotated along with the driving shaft, whereby the transmission member is horizontally movable between the first position and the second position in an axial direction of the driving shaft.

3. The window blind of claim 2, wherein the adjusting member comprises a bar and a switch member; the bar is parallel to the driving shaft; the switch member and the blocking member are connected to the bar, and are both not rotatable relative to the bar; the transmission member has a sloping surface; when the transmission member is moved toward the second position, the sloping surface gradually pushes the switch member toward outside to rotate the bar; the rotating bar moves the blocking member to leave the moving path of the projection of the friction ring.

4. The window blind of claim 2, wherein the adjusting member comprises a bar and an abutting member; the bar is parallel to the driving shaft; the abutting member and the blocking member are connected to the bar; when the transmission member is moved toward the second position, the transmission member pushes the abutting member to move the bar in the axial direction; the moving bar moves the blocking member to leave the moving path of the projection of the friction ring.

5. The window blind of claim 2, wherein the adjusting member comprises a base provided in the headrail; the control structure comprises a bolt, which has a head, a threaded body, and a shaft bore going through the head and the threaded body; the head has a circular groove, which is adapted to be engaged with a side wall of the base; the threaded body is located in the base, and forms the threaded portion; the driving shaft passes through the shaft bore, wherein the shaft bore corresponds to a shape of a cross section of the driving shaft, and the cross section is not circular.

6. The window blind of claim 5, wherein a vertical first abutting surface is provided on another side wall of the base, a second abutting surface is provided at another end of the transmission member, wherein the another end is opposite to the end with tapped hole;
the first abutting surface abuts against the second abutting surface, whereby the transmission member is not rotatable along with the driving shaft.

7. The window blind of claim 1, wherein the control structure comprises a reel fitting around the driving shaft and located on one side of the shaft seat to form the reeling portion; the reel is not rotatable relative to the driving shaft.

8. The window blind of claim 1, wherein the shaft seat of the adjusting member further has a second blocking portion, which is opposite to the first blocking portion; when the transmission member is moved to the second position and the other one of the fixing portions of the friction ring abuts against the second blocking portion, the friction ring stop rotating to stop tilting the slats.

9. The window blind of claim 1, wherein a circular recess recessed into the outer circular surface of the wheel; the friction ring is a semicircular frame, and two ends of the friction ring form the fixing portions; a rib bulges from the inner circular surface of the friction ring, and the rib is engaged with the circular recess.

10. The window blind of claim 1, wherein two circular recesses recess into the outer circular surface of the wheel; the friction ring comprises a first circular body and a second circular body which are connected to each other; the first circular body and second circular body are both discontinuous rings, each of which is greater than half of a circle; one of the fixing portions is formed at a free end of the first circular body, while the other one of the fixing portions thereof is formed at a free end of the second circular body; a rib bulges from an inner circular surface of the first circular body, and another rib bulges from an inner circular surface of the second circular body, wherein each of the ribs is engaged with one of the circular recesses.
